(19) United States
(12) Patent Application Publication
(10) Pub. No.: US 2010/0238354 A1
(43) Pub. Date: Sep. 23, 2010

(54) METHOD AND SYSTEM FOR ADAPTIVE NOISE REDUCTION FILTERING

(76) Inventors: Yaron SHMUELI, Kfar-Saba (IL); Efraim Shoham, Hadera (IL); Igal Dvir, Raanana (IL); Arie Yeredor, Kiryat-Ono (IL); Amotz Hoshen, RaMat Gan (IL)

Correspondence Address: Pearl Cohen Zedek Latzer, LLP, 1500 Broadway, 12th Floor, New York, NY, 10036, US

(21) Appl. No.: 12/406,617

(22) Filed: Mar. 18, 2009

(51) Int. Cl. H04N 5/00

(52) U.S. Cl. 348/607; 348/E05.001

(57) ABSTRACT

Embodiments of the invention are directed to a system and method for noise filtering in a video signal. The method includes dividing at least a portion of a frame into pixel groups and identifying a group as a first-type pixel group, possibly relating to a large change such as motion or light, if a difference parameter relating to the difference between the pixel group and a respective pixel group in a previous frame is larger than a threshold. The method further includes, identifying one or more of the first-type pixel groups as isolated pixel groups, if all the neighbors of the group are pixel groups with a difference parameter smaller than the threshold. The isolated pixel groups are redefined as pixel groups containing noise. The method further includes adapting the threshold based on the number of isolated pixel groups identified.

### BACKGROUND

Digital video compression may be used in a variety of implementations, such as broadcasting, streaming and storage. Video compression algorithms are based on reducing the quantity of data used to represent digital video images by reducing both spatial and temporal redundancies. Noise is an unwanted random pixel pattern in the video image. The existence of noise in the video images reduces redundancy and prevents video compression algorithms from working optimally.

One challenge of noise filtering is to distinguish between noise and actual changes in the video images, such as, motion or lighting change. Usually, noise may cause minor changes to the values of the image's pixels while actual changes such as motion may cause larger, major changes to the pixels' values. Commonly used noise filtering methods use a fixed threshold to decide which changes to filter. These methods, however, may result in creating ghost artifacts on moving objects.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an exemplary video encoder according to embodiments of the present invention;

FIG. 2 is a block diagram of an exemplary adaptive noise reduction filter in accordance with some illustrative embodiments of the present invention;

FIG. 3 is a high level flowchart of a method for adaptive noise reduction filtering according to embodiments of the present invention;

FIG. 4 is a high level flowchart of a method for adapting a threshold for noise reduction filtering according to embodiments of the present invention; and

FIGS. 5A and 5B are standard and bitmap representations of an exemplary picture frame of a video signal helpful in understanding embodiments of the present invention

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF DEMONSTRATIVE EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device such as a digital signal processor (DSP), an application-specific integrated circuit (ASIC) or a field-programmable gate array (FPGA) and the like, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Embodiments of the invention may include dividing at least a portion of a frame of a video signal containing image data into pixel groups, identifying one or more of the pixel groups as a first-type pixel group if a difference parameter relating to the difference between the pixel group and a respective pixel group in a previous frame is larger than a threshold having a first threshold value and identifying one or more of the first-type pixel groups as isolated pixel groups having as neighbors only pixel groups with a difference parameter smaller than the first threshold values. Embodiments of the invention may further include, adapting the threshold by changing the first threshold value to a second value based on the number of the isolated pixel groups and performing noise reduction filtering on at least a portion of the frame, filtering noise from isolated pixel groups and from pixel groups with a difference parameter smaller than the threshold values. Embodiments of the invention may further include, re-defining the isolated pixel groups from the first-type pixel groups to pixel groups containing noise, prior to filtering the noise from the frame and identifying one of more pixel groups of at least a portion of a subsequent frame as a first-type pixel group using the second threshold value.

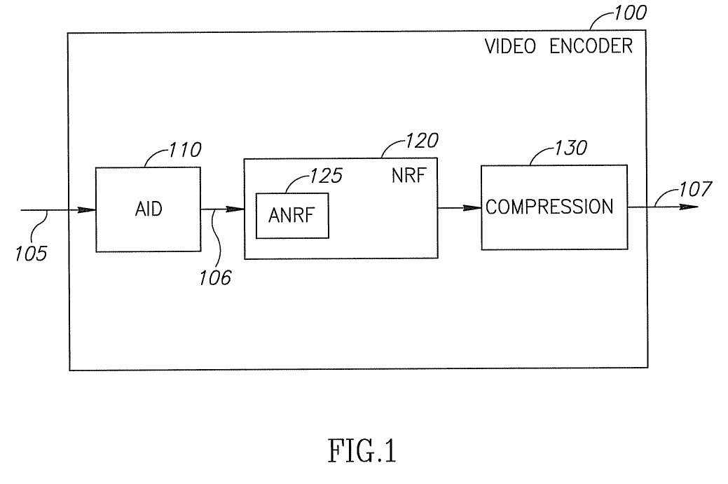

Reference is now made to FIG. 1, which is a block diagram of an exemplary video encoder according to embodiments of the present invention. It should be understood to a person skilled in the art that the video encoder presented in FIG. 1 may be implemented using any suitable hardware implementation, software application or any combination of software and hardware. An exemplary video encoder, such as video encoder 100 may encode or change an input video signal 105 into a code or data which may serve a number of purposes such as compressing information for transmission or storage. Although the present invention is not limited in this respect, video encoder 100 may include an analog to digital converter 110, a video compression unit 130 and a noise reduction filter unit (NRF) 120 that may include an adaptive noise reduction filter (ANRF) 125. Analog to digital converter 110 may convert the analog video signal 105 to a digital signal 106, for example, by converting an analog voltage or current to a digital number and to provide the digital signal to noise reduction filter unit 120. Digital video signal 106 may represent a video stream including a plurality of consecutive frames, images or pictures. In some embodiments, noise reduction filter unit 120 may receive the digital video signals directly from a sensor of a camera or any other external source.

Encoder 100 may include a video compression unit 130 to perform a compression operation and to generate a compressed output signal 107. The compression operation may be implemented using various algorithms such as, for example, JPEG, H.264, H.263, MPEG-2, MPEG-4. The compression algorithm performed by video compression unit 130 may be a lossy algorithm resulting in loss of certain amount of data during the compression process due to both spatially and temporally redundancies minimization.

Noise reduction filter unit (NRF) 120 which may decrease the noise level in video signal 106 by one or more noise reduction filters. NRF unit 120 may include an adaptive noise reduction filter (ANRF) 125. ANRF 125 may reduce the noise level in video signal 106 by adapting, changing or modifying its threshold value according to the noise level present in a current frame as described with reference to embodiments of the present invention.

Each video frame or at least a portion of a frame of video signal 106 may be divided into groups of pixels (GOP's) also referred to herein as “pixel groups”, for example, in the YCbCr color space, where Y is the luma component and Cb and Cr are the blue-difference and red-difference chroma components. Each GOP may include a plurality of pixels, for example, 4, 8, 16 or any other number of pixels which may be used as an atomic block of a frame for processing by one or more of the filters of NRF 120.

The difference between a pixel in a GOP within a frame and a respective pixel in the same location in a previous frame (or field in relation to interlaced scanning) may be compared to a threshold. Based on the comparison, also referred herein as “the threshold test”, it may be determined whether the difference is caused due to noise or to actual motion. The comparison of the difference between two GOP's of two consecutive frames to a threshold may be performed by comparing every pixel of a first GOP to the respective pixel of a second GOP of a consecutive frame. If one or more pair of pixels of two respective GOPs of two consecutives frames (a first pixel within a first frame and a respective second pixel in the same location in a previous frame) fails to pass the threshold test, namely the difference between the pixels is above the threshold, then the entire GOP may be declared or treated as a GOP which contains motion.

One or more filters of NRF 120 may use a fixed or constant threshold for the comparison of each component of the YCbCr color space as described in equation 1-3 below:

Δ_{Y(k,i)}=Y_{(n,i)}−Y_{(n-k,i)}>LumaTH (1)

Δ_{Cb(k,i)}=Cb_{(n,i)}−Cb_{(n-k,i)}>ChromaTH (2)

Δ_{Cr(k,i)}=Cr_{(n,i)}−Cr_{(r-k,i)}>ChromaTH (3)

Wherein Δ_{Y(k,i)}, Δ_{Cb(k,i)} and Δ_{Cr(k,i)} represents the difference between components (luma (Y) or chroma (Cb, Cr)) of pixels, from two consecutive GOPs, namely, a first GOP of a first frame and a second respective GOP of a second, consecutive or previous frame of video signal 106. The index i may indicate a pixel in a GOP and the index n may represent a frame of a video signal. The index k may represent a field or a frame with respect to the scanning method used for scanning of video signal 105.

Embodiments of the invention may be related to a plurality of video scanning methods. For example, progressive scanning or interlace scanning. Interlaced scanning of a frame may result in odd and even scanning lines (fields) that may be equal in size to progressive scanning results of a frame. Video signal 106, scanned by progressive scanning may also include two fields, in order to comply with digital video standards. The difference between interlace and progressive video scanning is the sample time, e.g., while interlace scanning may sample a field at different timings, progressive scanning may sample fields at a same time. A field may also be referred to herein as “a portion of a frame”.

Therefore, with relation to interlaced scanning, k may indicate a field which contains only half of the scanned lines of a frame, while in progressive scanning k may indicate a full frame. The values Δ_{Y(2,i)} and/or Δ_{Y(1,i)} with respect to interlaced scanning, may represent the difference between a first field of a first frame and a respective first field of a second frame, consecutive to the first frame. In another example, the value Δ_{Y(1,i)}, with respect to progressive scanning, may represent the difference between a first frame and a second, consecutive frame.

Although the invention is not limited in this respect, one or more filters included in NRF 120 may compare the values Δ_{Y(k,i)}, Δ_{Cb(k,i)} and Δ_{Cr(k,i)} to a respective constant threshold in order to determine whether a change between two fields or two frames is caused due to actual changes in a scene, such as, for example, motion, or due to noise level which may be filtered out as to avoid artifacts.

According to embodiments of the present invention, ANRF 125 may adapt, change or modified the threshold value according to the noise level presents at a field or frame. For example, a constant threshold suitable for a scene with a certain noise level may not be sufficient to distinguish between an actual change and noise in a scene with a higher noise level since the difference between an actual change and noise may be small in the high noise level scene. As another example, a change in the amount of light being captured by a video acquisition device may influence the noise level in the video signal, for example, the differences between the intensity of light during day and night times. While a constant threshold may be sufficient for nighttime, when the noise level is high, a lower threshold may be needed for daytime to avoid false detection of motion as noise creating ghost artifacts.

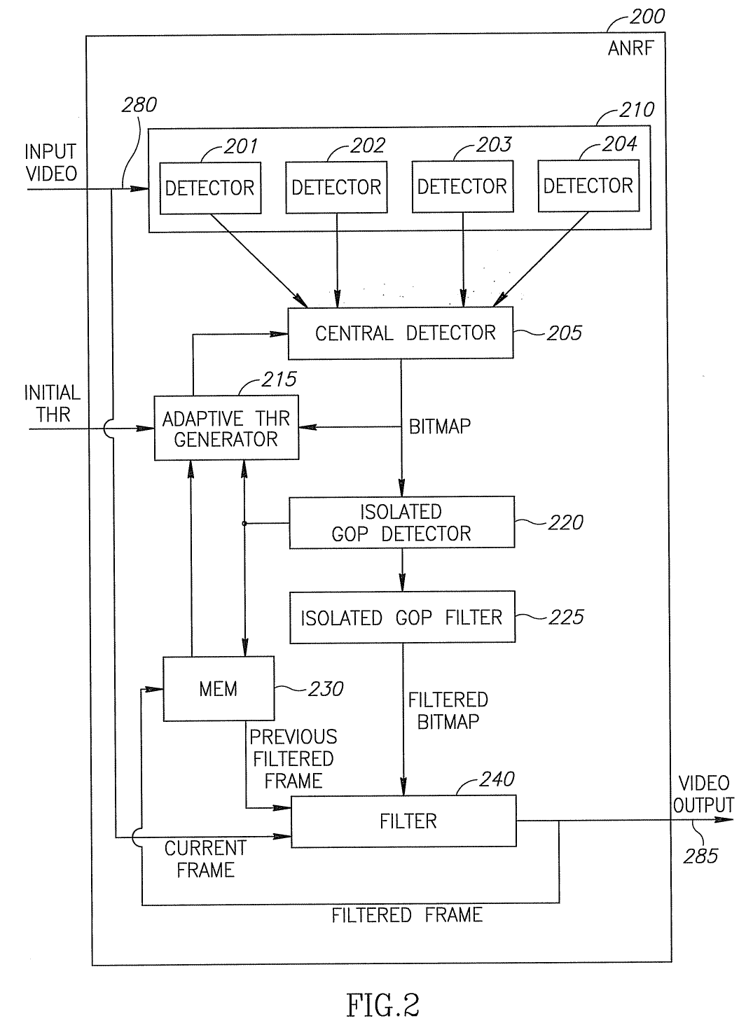

Reference is made to FIG. 2, which schematically illustrates an adaptive noise reduction filter 200 in accordance with some illustrative embodiments of the present invention. ANRF 200 may include a detector array 210, a central detector 205 coupled to detector array 210, an adaptive threshold generator 215 and an isolated group-of-pixels (GOP) detector 220, each coupled to central detector 205. ANRF 200 may further include an isolated GOP filter 225 coupled to isolated GOP detector 220, a memory 230 coupled to both adaptive threshold generator 215 and to isolated GOP detector 220 and a noise filter 240 coupled to both isolated GOP filter 225 and to memory 230. Although the invention is not limited in this respect, ANRF 200 may perform the functionality of ANRF 125 of FIG. 1.

ANRF 200 may receive an input video signal 280. The input signal 280 may be received, frame by frame, by detector array 210 and, in parallel, each frame of input signal 280 may be saved in memory 230. Detector array 210 may include a plurality of detectors, for example, four detectors 201, 202, 203 and 204. Each detector may receive each frame of input signal 280, may detect certain signal levels of the frame, calculate certain values of the frame and may generate a frame map. The frame map may indicate areas in the frame which may include a change from a previous frame or field of frame.

The detected values calculated by detectors 201-204 may be used to distinguish noise from actual changes of a scene in order to filter noise from the video signal. The frame map may be a bitmap representing GOP's. Each GOP may have the value “1” (TRUE) or “0” (FALSE), where TRUE represent a difference above the threshold from a previous GOP. Accordingly, TRUE indicates that the GOP has passed the threshold test and was recognized as containing motion or any other actual change, such as light change and accordingly no GOP filtering is required. FALSE represents a difference smaller than the threshold from the previous GOP. Accordingly, False indicates that the GOP has not passed the threshold test and was recognized as a static or noisy GOP and therefore GOP filtering may be required.

Embodiments of the invention may include, one or more detectors to identify one or more pixel groups from at least a portion of a frame of a video signal containing image data as a first-type pixel group if a difference parameter relating to the difference between the pixel group and a respective pixel group in a previous frame is larger than a first value of a threshold. The detectors may calculate for each of the pixel groups, parameters related to pixels of the group and corresponding parameters related to pixels of a respective pixel group of the previous frame, may generate the difference parameter based on the calculated parameters and may compare the difference parameter to the threshold.

An exemplary set of detectors 201-204 designed for GOP's having four pixels are represented by equations 4-7 below, where the index “t” indicates a pixel in a detected GOP. It should be understood to a person skilled in the art that although four detectors are described in the exemplary illustration of FIG. 2, any number of detectors able to perform any mathematical calculation on any number of pixels may be used.

Equation 4 represents an exemplary detector, x₁, that detects a change in a GOP by calculating the square sum of the differences between two consecutive GOP's. The value Δ_{(2,t)} with respect to interlaced scanning may represent a difference between a field of a first frame and a respective field of a second frame, consecutive to the first frame.

$${x}_{1} = {( {\sum }_{t = 1}^{4} {Δ}_{( 2 , t )} )}^{2} \qquad ( 4 )$$

Equation 5 represents another exemplary detector, x₂, able to detect a vertical change in a GOP.

x₂=((Δ_{(2,1)}+Δ_{(2,3)})−(Δ_{(2,2)}+Δ_{(2,4)}))² (5)

Equation 6 represents another exemplary detector, x₃, able to detect a horizontal change in a GOP.

x₃=((Δ_{(2,1)}+Δ_{(2,2)})−(Δ_{(2,3)}+Δ_{(2,4)}))² (6)

Equation 7 represents another exemplary detector, x₄, able to detect a change in a GOP by calculating the square sum of the differences between two consecutive GOP's and multiplying it by a decay coefficient K.

$${x}_{4} = {K ( {\sum }_{t = 1}^{4} {Δ}_{( 1 , t )} )}^{2} \qquad ( 7 )$$

The value Δ_{(1,t)} with respect to interlaced scanning may represent a difference between a field of a first frame and a respective field of a second frame, consecutive or previous to the first frame. The field chosen in detector x₄ may be different from the field chosen in detector x₁, namely, the other field of the interlaced scanning, and the decay coefficient K, which may be an inter field constant, may be used as a weight in the calculation to distinguish the calculation related to a field from a calculation related to a frame or to another field, e.g., detector x₁.

Central detector 205 may receive the detected values from each of detectors 201-204 and may generate, compute or calculate a value or a difference parameter, referred to herein as “S”, with respect to the detected frame. Although the present invention is not limited in this respect, central detector 205, also referred to herein as “standard deviation detector” or “S detector” may measure, compute or detect the standard deviation, namely the dispersion of the values detected by detectors x₁-x₄ around the mean or average of the values detected by detectors x₁-x₄, represented by equations 8 and 9:

$$\begin{matrix}\overline{x} = \frac{1}{n} {\sum }_{m = 1}^{n} {x}_{m} & ( 8 ) \\ S = {( \frac{1}{n} {\sum }_{m = 1}^{n} {( {x}_{m} - \overline{x} )}^{2} )}^{1 \text{/} 2} & ( 9 )\end{matrix}$$

where m represents the selected detector and n represents the general number of detectors. In these exemplary embodiments n equals 4. It should be understood to a person skilled in the art that central detector 205 may calculate any other mathematical value or a difference parameter with respect to the number of the detectors and the calculated values of the detectors.

Central detector 205 may further receive a new value for an adaptive threshold generated by threshold generator 215 and may compare the parameter S to the received adaptive threshold in order to decide whether a certain GOP can be recognized as an “actual-change GOP”. A GOP may be recognized as a “motion GOP” or an “actual-change GOP” if the difference between a GOP of a current frame and a respective GOP in a previous frame is above the adaptive threshold. In such a case, the difference is considered to have occurred due to actual changed in the video signal such as motion or light intensity changes.

Central detector 205 may generate a bitmap based on the comparisons of the value S calculated for each GOP and the adaptive threshold received from threshold generator 215. If S is larger than the adaptive threshold value, the GOP may be recognized as a “motion GOP” or “large-change GOP”. For motion GOP's, the GOP location in the generated bitmap may be given a value of “1” to indicate that no noise filtering is required. Throughout the Specification and claims, the term “motion GOP”, should be broadly construed to include any large change in that is a result of a physical change on the scene, including changes in light intensity and noise.

If S is smaller than the adaptive threshold, the difference between the GOP and the previous GOP may be considered to be caused by noise. Accordingly, such a GOP may be recognized as “static GOP”, the GOP location in the generated bitmap may be given a value of “0” and accordingly that GOP would be filtered. The bitmap generated by central detector 205 may be input to threshold generator 215 and may be used for calculation of the threshold of the next frame. Threshold generator 215 may receive an initial threshold from a user or a system administrator and the bitmap generated by central detector 205 and may change, modified or adapt the threshold based on input received from isolated GOP detector 220 and previous frame received from memory 230.

Isolated GOP detector 220, also referred to herein as “isolated pixel groups detector 220”, may receive the bitmap from central detector 205 and may determine and identify whether a GOP is an “isolated motion GOP”, namely, a “motion GOP” surrounded with only “static GOP's”. Isolated GOP detector 220 may identify one or more of the first-type pixel groups (motion GOPs) as isolated pixel groups (isolated motion GOP) having as neighbors only pixel groups with a difference parameter smaller than the threshold.

The determination regarding each of the GOP's of the bitmap, namely the GOP's to be eliminated, may be transferred to the isolated GOP filter 225 and to memory 230. Isolated GOP filter 225 may filter the “isolated motion GOP's” in the bitmap by eliminating them and may transfer the filtered bitmap to noise filter 240 which may filter video frames according to the filtered bitmap. Isolated pixel groups detector 220 may re-define the isolated pixel groups from being first-type pixel groups (motion GOPs) to pixel groups containing noise, prior to filtering the noise from the frame by other filters, e.g., filter 240.

Filter 240 may filter a video frame in the locations of GOP's identified as “static GOP's” and “isolated motion GOP” and may not filter in locations of GOP's identified as “motion GOP's” which are not “isolated motion GOP's”. The results of filter 240 may be saved in memory 230 so that in each filtering cycle a current frame may be filtered by filter 240 with relation to the previous filtered frame saved in memory 230. Filter 240 and Isolated GOP filter 225 may filter noise from isolated pixel groups and from pixel groups with a difference parameter smaller than the threshold.

Filter 240 may include any method or mathematical algorithm to remove noisy parts of the input video signal. An exemplary noise reduction filter according to embodiments of the invention may include a temporal Infinite impulse response (IIR) filter scheme. A current input frame may be compared to a previous filtered frame received from memory 230 and only the weighted changes of a frame in comparison to a previous filtered frame may be updated, such as to apply an averaging window over time on video signal as represented by equations 10 and 11 below:

Fn=Ffiltered n−1+((Fn−Ffiltered n−1)>>FilterSize) (10)

Fn=Ffiltered n−1−((Ffiltered n−1−Fn)>>FilterSize) (11)

where Fn represents the current input video frame and Ffiltered n−1 represents the previous filtered video frame. FilterSize is the parameter controlling the filtering depth, giving priority to previous frames or the current frame. The sign may change, namely, the use of equations 10 or 11 may be changed per frame in order to maintain convergence when using fix point mathematics.

In some cases, the parameter S calculated for a certain GOP may be larger than the threshold even though the GOP does not represent an actual change in the scene. For example, a GOP may pass the “threshold test”, namely, the parameter S calculated for a GOP by central detector 205 may be larger than the threshold due to a high noise level and not due to an actual motion in the GOP. GOP's which may be considered erroneously as “motion GOP's” but may have no actual motion may be detected as such by isolated GOP detector 220.

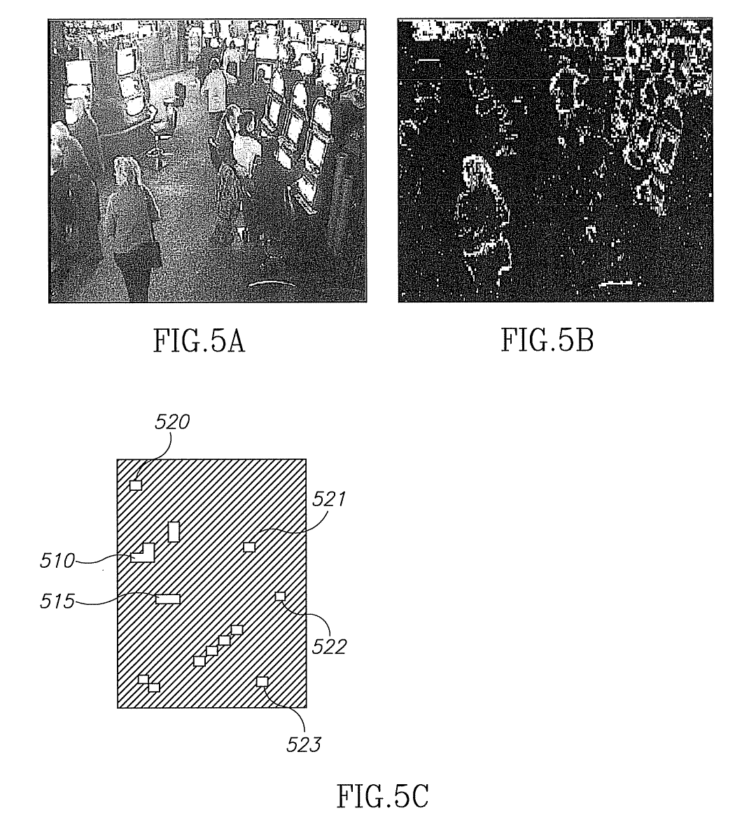

Reference is made to the exemplary picture frame of a video signal represented in FIG. 5A and the respective bitmap image represented in FIG. 5B. The bitmap image of FIG. 5B is based on a comparison of the parameter “S” to the adaptive threshold by central detector 205. The white areas represent “motion GOP's” and the black areas represent “static GOP's”. FIG. 5C is an enlargement of a section of the bitmap of FIG. 5B demonstrating the difference between a real “motion GOP” “noisy GOP” that resembles a motion GOP. Real “motion GOP's” are represented by white areas grouped together, namely, GOP's having one or more neighboring motion GOP's. For example, each of areas 510 and 515 includes more that one white GOP and therefore are recognized as motion GOP's. False “motion GOP's”, which are actually “noisy GOP's” are the “isolated motion GOP's” represented by isolated white areas for example, GOP's 520,521, 522 and 523.

Referring back to FIG. 2, isolated GOP detector 220 may search for an “isolated motion GOP” by using, for example, a filter mask. An exemplary filter mask is presented in equation 12 below:

$$MASK = [ \begin{matrix}- 1 & - 1 & - 1 \\ - 1 & 9 & - 1 \\ - 1 & - 1 & - 1\end{matrix} ] \qquad ( 12 )$$

According to embodiments of the present invention, isolated GOP (pixel group) detector 220 may perform convolution of the predetermined filter mask with the values of the pixels of each GOP or pixel group of the frame in the bitmap received from central detector 205. The mask may scan all GOP's by multiplying the values of the mask by the respective values of the pixel of the GOP's and summing the results. The isolated GOP's may be identified as those that for them the masking operation results in the value of the mask's center, which is (9) in the exemplary mask of equation 12. The reason for this result is because the bitmap would include the value of “1” surrounded by “0's”. It should be understood to a person skilled in the art that the mask described is an exemplary mask and any other masks may be used.

The number of the detected “isolated motion GOP's” may represent the noise level of a frame and therefore may indicate the level of filtering required. Threshold generator 215 may receive an indication of the number of the “isolated motion GOP's” from isolated GOP detector 220 and may adapt, change or modify a first threshold value to a second value according to the received indication based on the number of the isolated pixel groups. The “isolated motion GOP's”, that may represent noise that was not detected as such by central detector 205 may be considered as “false motion GOP's”. By increasing the value of the adaptive threshold more “false motion GOP's” may be filtered on the next frame so the number of “isolated motion GOP's” may be decreased. Reducing the adaptive threshold may increases the number of “isolated motion GOP's” and less noise may be filtered. The goal of adapting the threshold is to maintain a constant ration between the number of “isolated motion GOP's” and the number of isolates and non-isolated (total) “motion GOP's”

Modifying or changing the adaptive threshold based on the number of “isolated motion GOP's” that have passed a current adaptive threshold may enable convergence of the adaptive threshold and adaptation of the adaptive threshold to the noise level of a video signal. Although the present invention is not limited in this respect, the number of detected “isolated motion GOP's” may be averaged with the number of detected “isolated motion GOP's” of a previous frame to avoid discontinuity.

Threshold generator 215 may calculate the ratio between the number of isolated motion GOP's (isolated pixel groups) and the number of non-isolated motion GOP's (non-isolated pixel groups). The non-isolated motion GOP's may represent GOP's that have passed the adaptive threshold test, recognized as motion GOP's and are located in proximity or in adjacency to at least another motion GOP. In other words, non-isolated pixel groups may be identified as one or more of the first-type pixel groups having one or more neighboring pixel groups with a difference parameter larger than the threshold value. The non-isolated motion GOP's may be a plurality of motion GOP's arranged in a group.

Threshold generator 215 may compare the ratio between the number of isolated motion GOP's to the number of non-isolated motion GOP's to predetermined minimum and maximum noise parameters. If the ratio is above the maximum noise parameter, threshold generator 215 may increase the adaptive threshold, for example, by a step size parameter. If the ratio is below the minimum noise parameter, threshold generator 215 may decrease the adaptive threshold, for example, by the step size parameter. The value of the adaptive threshold may be changed in a value range between the minimum noise parameter and the maximum noise parameter.

According to embodiments of the present invention, threshold generator 215 may reset the adaptive threshold and may begin the threshold adaptation process from a starting point when a change in the characteristics of a scene of the video signal in terms of noise and motion is detected. Scene change detection may be performed, for example, by comparing the number of GOP's recognized as non-isolated motion GOP's at a current frame to the number of GOP's recognized as non-isolated motion GOP's at previous frames.

Scene change detection may be used in a variety of applications such as, for example, in closed-circuit television (CCTV) applications where multiple video channels may be switched on a single video input signal and the adaptive mechanism may be reset per channel switch.

Although embodiments of the present invention are not limited in this regard, memory 230 may further include a computer-storage medium having stored thereon instructions that when executed may perform the threshold adaptation process and adaptive noise filtering described in embodiments of the present invention.

Other embodiments of the invention may include identifying a pixel group as a first-type pixel groups based on a difference parameter between pairs of pixels, each belonging to a different one of subsequent frames. If the difference parameter of at least one pair of pixel is above a certain threshold (pixel-threshold), than the pixel group is considered a first-type group (or motion GOP). Namely, even if only one pixel of a GOP is larger than a threshold value that may be a non-adaptive threshold, the entire GOP may be considered as a “motion GOP” or a first-type pixel group and a bitmap may be created for such a frame. If, for example, some GOP's where identified as “motion GOP's” based on the single pixel test, embodiments of the invention may include generating a bitmap which is a logical function such as, for example, logical “OR” between a bitmap created by the plurality of the detectors and the bitmap created after the comparison of each pixel difference to the non adaptive threshold. The result bitmap may be forwarded to the filters to be filtered from noise.

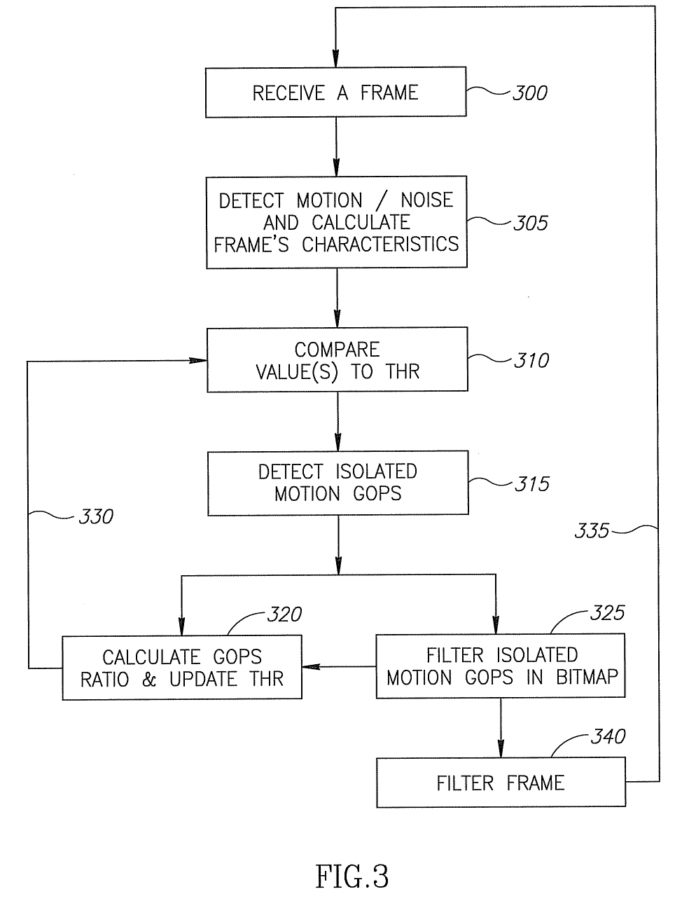

Reference is now made to FIG. 3, which is a high level flowchart of a method for adaptive noise reduction filtering according to embodiments of the present invention. Operations of the method may be implemented by, for example, ANRF 125 of FIG. 1, ANRF 200 of FIG. 2 and/or by other suitable units, devices, and/or systems.

As indicated at box 300, the method may include receiving a frame of a video signal by a plurality of detectors of an ANRF, for example, by detectors 201-204 of encoder 200 of FIG. 2. The method may further include saving the received frame of the video signal in a dedicated memory or storage unit, for example, memory 230 of FIG. 2.

As indicated at box 305, the method may include detecting noise and/or motion in the received frame by a plurality of detectors and calculating a plurality of frame's characteristics and mathematical values which represent the detected amount of noise or motion. The detected characteristics represented by the calculated values may correspond to the pixels of the current received frame and the pixels of a previously received frame.

The method may include calculating values related to each pixel of a pixel group (GOP) and corresponding values related to each pixel of a respective pixel group of the previous frame and generating a difference parameter based on one or more of the values.

According to some exemplary embodiments of the invention, the detected values may be, for example, the square sum of the difference between two consecutive GOP's, the square sum of the difference between two consecutive GOP's multiplied by a coefficient, vertical change in a GOP and horizontal change in a GOP. In some embodiments of the invention, the detected values may be a function of other detected values, for example, central detector 205 of FIG. 2 may calculate the standard deviation of previously calculated values from other detectors, for example, detectors 200-204 of FIG. 2.

As indicated at box 310, the method may include comparing a detected value, e.g., a difference parameter, related to the difference between pixels of a GOP and pixels of a GOP in the same location in a consecutive or previous frame (or field of a GOP in relation to interlaced scanning) to a first value of an adaptive threshold. The comparison to the adaptive threshold may be performed in order to decide whether a certain GOP should be recognized as a motion GOP.

If the detected value is larger than the adaptive threshold, the GOP may be defined as a motion GOP whereas if the detected value is smaller than the adaptive threshold the GOP may be defined as noisy GOP.

As indicated at box 315, the method may include detecting isolated motion GOP's. An isolated motion GOP may be defined as a GOP previously recognized as a motion GOP and surrounded by GOP's that were not recognized as motion GOP's. An isolated motion GOP may actually be a noisy GOP that passed the adaptive threshold test due to high level of noise. A large number of isolated motion GOP's or a small number of isolated motion GOP's may indicate that the threshold is needed to be adapted to the current conditions of the video signal.

Detecting the isolated motion GOP's may be performed, for example, by using a predetermined filter mask and performing convolution of the filter mask, such as the filter represented by equation 12 with the bitmap created by, for example, central detector 205 of FIG. 2.

According to embodiments of the present invention, the number of the recognized isolated motion GOP's may indicate the noise level. The existence of a higher number of isolated motion GOP's in a frame with respect to previous frames may serve as an indication for the need to adapt, change or modified the adaptive threshold.

As indicated at box 320, the method may include calculating the ratio between the number of isolated motion GOP's to the total number of motion GOP's that includes both isolated motion GOP's and non-isolated motion GOP's. The non-isolated motion GOP's may represent GOP's which passed the adaptive threshold, considered as “motion GOP's” and are in proximity or in adjacency to other one ore more motion GOP's. The “non-isolated motion GOP's” may be a plurality of “motion GOP's” arranged in a group.

The method may further include updating, adapting or modifying a threshold value according to the number of isolated motion GOP's. The method may include comparing the ratio between the number of isolated motion GOP's to the number of non-isolated motion GOP's to minimum and maximum noise parameters. When the ratio is above the maximum noise parameter, the method may increase the adaptive threshold, for example, by a step size parameter. When the ratio is below the minimum noise parameter, threshold the method may decrease the adaptive threshold, for example, by the step size parameter.

As indicated at box 325, the method may include filtering the isolated motion GOP's that are probably noisy GOP's. Filtering isolated motion GOP's may be performed by eliminating the isolated motion GOP's in the bitmap, e.g., converting GOP's having a value of “1” to “0”. The bitmap may be used in both the filtering process indicated at box 340 and in the threshold updating process indicated at box 320.

As indicated at box 340, the method may include filtering noise out of a video frame based on the filtered bitmap. The filtering may include filtering the video frame in the locations of both the static or noisy GOP's and the isolated motion GOP's but not in the locations of the non-isolated motion GOP's. For example, the filtering process may filter GOP's marked with “0” in the bitmap and maintain GOP's marked with “1” in the bitmap. The filtering process may include any method or algorithm capable of removing to remove parts, e.g., noise from the input video signal. The filtered frame may be saved in a dedicated memory or storage unit, and may be used in the filtering process of the next frame.

After the filtering process is performed, the method may receive the next frame as indicated by arrow 335. This frame may be processed using the updated threshold (arrow 330). Other operations or sets of operations may be used in accordance with embodiments of the invention.

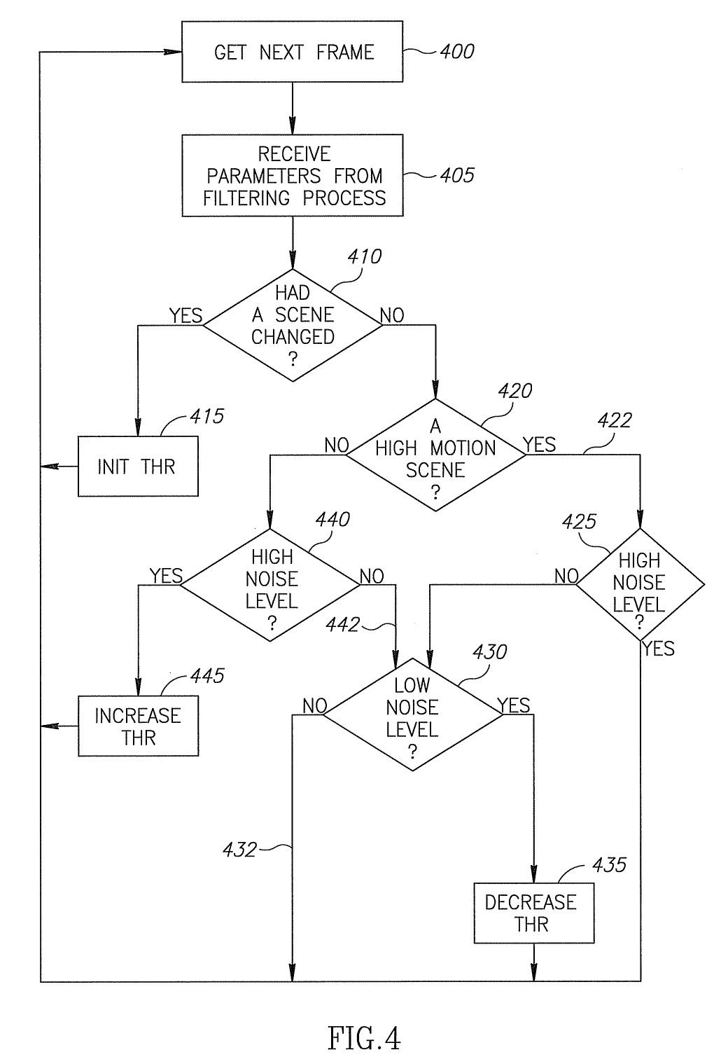

Reference is now made to FIG. 4, which is a high level flowchart of a method for adapting a threshold for noise reduction filtering according to embodiments of the present invention. Operations of the method may be implemented by, for example, ANRF 125 of FIG. 1, ANRF 200 of FIG. 2 and/or by other suitable units, devices, and/or systems. As indicated at box 400, the method may include receiving a frame of a video signal by a plurality of detectors of an ANRF, for example, by detectors 201-204 of FIG. 2.

As indicated at box 405, the method may include receiving input or parameters from the filtering process described with reference to FIG. 2 and FIG. 3. The parameters may include, for example, the number of the isolated GOP's eliminated from the previous frame and the ratio between the number of isolated motion GOP's to the total number of motion GOP's of the previous frame. Based on the received parameters the determination regarding updating the threshold may be taken as described with reference to FIG. 4.

As indicated at decision point 410, the method may include determining whether a scene had changed between the current frame and previous frame. The determination regarding a scene change may be performed by comparing the number of GOP's eliminated in a current frame to the number of GOP's eliminated in a previous frame.

When the number of GOP's eliminated in a current frame is larger than the number of GOP's eliminated in a previous frame, it may indicate that there is a substantial change between the frame and the previous frame. Such a change between the frame and the previous frame may lead to a determination that a scene change had happened and the threshold may be initialized to a reset value as indicated at box 415 as to allow a new iteration of the filtering process with the initialized threshold.

If the number of GOP's eliminated or filtered in a current frame is not larger than the number of GOP's eliminated or filtered in a previous frame, it may indicate that no large change between the frame and the previous frame had occurred and the method may include another decision point to determine whether a scene is a high-motion scene or not (decision point 420).

The determination whether a scene is a high-motion scene may include comparing the number of GOP's eliminated or filtered in a current frame to a predetermined value. The predetermined value also referred to herein as “frame motion threshold” may be defined by a user and may relate to the application or other characteristics of the video signal. For example, movements of a pan, tilt, zoom (PTZ) camera may cause a high-motion scene and a high percentage of the GOP's may be eliminated by the filtering process. If it was determined that the scene is a high-motion scene, as indicated by arrow 422, the method may include another decision point to determine the level of noise (decision point 425). If it is determined that a high noise level exists, no change in the threshold may be required whereas if it is determined that a low noise level exists, a decrease of the threshold may be required.

As indicated at decision point 425, if a scene is considered to be a high-motion scene, the method may include checking the noise level by comparing the density of the filtered isolated motion GOP's of a frame (the amount of isolated GOP's compared to the amount of GOP's to be filtered) to the product of a predetermined parameter referred to herein as a “maximum noise parameter” multiplied by the area covered by non-filtered GOP's.

If the density of the filtered isolated motion GOP's is larger than the product of the maximum noise parameter multiplied by the area covered by non-filtered GOP's, the method may continue the filtering process (starting at box 400) without adapting the threshold, using the same threshold of previous iteration.

If the density of the filtered isolated motion GOP's is not larger than the product of the maximum noise parameter multiplied by the area covered by non filtered GOP's, the method may include further analysis of the noise level as indicated at decision point 430. The analysis may be performed by comparing the density of the filtered isolated motion GOP's of a frame to the product of a predetermined parameter referred to herein as a “minimum noise parameter” multiplied by the area covered by non-filtered GOP's.

If the density of the filtered isolated motion GOP's is smaller than the product of the minimum noise parameter multiplied by the area covered by non filtered GOP's, it may indicate that the threshold is too high and therefore the method may include decreasing the threshold as indicated at box 435. The decrease of the threshold may be performed, for example, by choosing the maximum value between a predetermined minimum threshold and the current threshold decreased by a step size parameter as shown in equation 13:

Max (Threshold−Step size, minimum Threshold) (13)

After decreasing the threshold, the method may continue by repeating the filtering process starting at box 400 using the decreased value as a new threshold.

If the density of the filtered isolated motion GOP's is larger than the product of the minimum noise parameter multiplied by the area covered by non-filtered GOP's, (indicated by arrow 432), the method may continue by repeating the filtering process starting at box 400 using the same threshold used in the previous iteration without modifying it.

Referring back to decision point 420, if it was determined that the scene is not a high-motion scene, the method may include another decision point to determine the level of noise (decision point 440). As indicated at decision point 440, if a scene is not considered a high-motion scene, the method may include checking the noise level by comparing the density of the filtered isolated motion GOP's of a frame to the product of the “maximum noise parameter” multiplied by the area covered by non-filtered GOP's.

If the density of the filtered isolated motion GOP's is larger than the product of the maximum noise parameter multiplied by the area covered by non-filtered GOP's, it may indicate that the threshold is too low and therefore the method may include increasing the threshold as indicated at box 445. The increase of the threshold may be performed, for example, by choosing the minimum value between a predetermined maximum threshold and the current threshold increased by a step size parameter as shown in equation 14:

Min (Threshold +Step size, maximum Threshold) (14)

After increasing the threshold, the method may continue by repeating the filtering process starting at box 400 using the decreased value as a new threshold.

If the density of the filtered isolated motion GOP's is not larger than the product of the maximum noise parameter multiplied by the area covered by non filtered GOP's (as indicated by arrow 442), the method may include further analysis of the noise level as indicated at decision point 430. If the density of the filtered isolated motion GOP's is smaller than the product of the minimum noise parameter multiplied by the area covered by non filtered GOP's, it may indicate that the threshold is too high and therefore the method may include decreasing the threshold as indicated at box 435. After decreasing the threshold, the method may continue by repeating the filtering process starting at box 400 using the decreased value as a new threshold. If the density of the filtered isolated motion GOP's is larger than the product of the minimum noise parameter multiplied by the area covered by non-filtered GOP's, (indicated by arrow 432), the method may continue by repeating the filtering process starting at box 400 using the same threshold used in the previous iteration without modifying it.

It should be understood to a person skilled in the art that other operations or sets of operations may be used in accordance with embodiments of the invention. Embodiments of the invention may provide a robust method which may be used with a variety of noise sources, light conditions and video compression rates. For example, since the threshold adaptation process is not related to the noise pattern itself, it may be used in any application having any kind of video signal. Embodiments of the present invention may reduce encoding complexity by decreasing high frequencies and changes in the encoded frame. In addition the method used by embodiments of the invention may enlarge the number of bits used in encoding motion frames on the expense of saving bits in encoding static noisy frames.

Although not limited in this regard the present invention may be used to improve video quality, improve compression rate and reduce storage requirements as well as for detection of changes, such as a scene change, PTZ in motion or PTZ level of filtering.

Some embodiments may be provided in a computer program product that may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for image processing comprising:
dividing at least a portion of a frame of a video signal containing image data into pixel groups;
identifying one or more of the pixel groups as a first-type pixel group if a difference parameter relating to the difference between the pixel group and a respective pixel group in a previous frame is larger than a threshold having a first threshold value;
identifying one or more first-type pixel groups as an isolated pixel group having as neighbors only pixel groups with a difference parameter smaller than the first value of the threshold;
adapting the threshold by changing the first threshold value with a second threshold value based on the number of isolated pixel groups identified; and
performing noise reduction filtering on the frame, filtering noise from the isolated pixel groups and from pixel groups with a difference parameter smaller than the first threshold value.

2. The method of claim 1 comprising:
re-defining the isolated pixel groups from the first-type pixel groups to pixel groups containing noise, prior to filtering the noise from the frame.

3. The method of claim 1, comprising:
identifying one of more pixel groups of at least a portion of a subsequent frame as first-type pixel groups using the second threshold value.

4. The method of claim 1, wherein identifying the first-type pixel groups comprises, for each of the pixel groups:
calculating parameters related to each pixel and corresponding parameters related to each pixel of a respective pixel group of the previous frame;
generating the difference parameter based on one or more of the parameters; and
comparing the difference parameter to the first threshold value.

5. The method of claim 1 comprising:
identifying one or more of the first-type pixel groups as non-isolated pixel groups having one or more neighboring pixel groups with a difference parameter larger than the first threshold value.

6. The method of claim 1 comprising:
performing convolution of a predetermined mask with the values of the pixels of each pixel group of the frame.

7. The method of claim 5, wherein adapting the threshold comprises:
calculating a ratio between the number of the isolated pixel groups and the number of the non-isolated pixel groups; and
increasing the threshold, if the ratio is above a predetermined maximum parameter.

8. The method of claim 1, wherein adapting the threshold comprising:
calculating a ratio between the number of the isolated pixel groups and the number of the non-isolated pixel groups; and
decreasing the threshold if the ratio is below a predetermined minimum parameter.

9. The method of claim 1, wherein performing noise reduction filtering comprises:
updating weighted changes of the frame in comparison to a previous filtered frame.

10. The method of claim 1, comprising:
identifying one or more of the pixel groups as a first-type pixel group if the difference between at least one pixel and a respective pixel in a previous frame is larger than the a pixel threshold value.

11. An image processing system comprising:
one or more detectors to identify one or more pixel groups of at least a portion of a frame of a video signal containing image data as a first-type pixel groups if a difference parameter relating to the difference between the pixel group and a respective pixel group in a previous frame is larger than a threshold having a first threshold value;
an isolated pixel groups detector to identify one or more of the first-type pixel groups as isolated pixel groups having as neighbors only pixel groups with a difference parameter smaller than the threshold;
a threshold generator to adapt the threshold by changing a first threshold value with a second threshold value based on the number of the isolated pixel groups identified;
a filtering unit to filter noise from the isolated pixel groups and from pixel groups with a difference parameter smaller than the threshold.

12. The system of claim 11, comprising an isolated pixel groups filter to re-define the isolated pixel groups from the first-type pixel groups to pixel groups containing noise, prior to filtering the noise from the frame.

13. The system of claim 11, wherein the detectors calculate for each of the pixel groups, parameters related to pixels of a pixel group and corresponding parameters related to pixels of a respective pixel group of the previous frame, generate the difference parameter based on one or more of the parameters and compare the difference parameter to the threshold.

14. The system of claim 12, wherein the isolated pixel groups detector performs convolution of a predetermined mask with the values of the pixels of each pixel group of the frame.

15. The system of claim 11, wherein the threshold generator is to calculate a ratio between the number of the isolated pixel groups and the number of non-isolated pixel groups, wherein the non-isolated pixel groups are first-type pixel groups having one or more neighboring pixel groups with a difference parameter larger than the threshold.

16. The system of claim 15, wherein the threshold generator is to increase the threshold if the ratio is above a predetermined maximum parameter and to decrease the threshold if the ratio is below a predetermined minimum parameter.

17. The system of claim 11, wherein the filtering unit is to perform noise reduction filtering on the frame by updating weighted changes of at least a portion of the frame in comparison to a previous filtered frame.

18. The system of claim 10, wherein the threshold generator is to reset the threshold to a predetermined value when a change in the characteristics of the video signal is detected.

19. An article comprising a computer-storage medium having stored thereon instructions that, when executed by a processing platform, result in:
dividing at least a portion of a frame of a video signal containing image data into pixel groups;
identifying one or more of the pixel groups as a first-type pixel groups if a difference parameter relating to the difference between the pixel group and a respective pixel group in a previous frame is larger than a threshold having a first threshold value;
identifying one or more of the first-type pixel groups as isolated pixel groups having as neighbors only pixel groups with a difference parameter smaller than the first threshold value;
adapting the threshold by changing the first threshold value to a second threshold value based on the number of the isolated pixel groups identified; and
performing noise reduction filtering on the frame, filtering noise from isolated pixel groups and from pixel groups with a difference parameter smaller than the first threshold value.

20. The article of claim 19, wherein the instructions when executed further result in:
identifying one of more pixel groups of at least a portion of a subsequent frame as first-type pixel groups using the second threshold value.
